(19) United States
(12) Patent Application Publication
(10) Pub. No.: US 2009/0055302 A1
(43) Pub. Date: Feb. 26, 2009

(54) System and method for integrating a convertible security with a call spread

(76) Inventors: Daniel Breen, Water Mill, NY (US); Herman Hirsch, New York, NY (US)

Correspondence Address: KING & SPALDING LLP (CITI CUSTOMER NUMBER);ATTN: GEORGE T. MARCOU, 1700 PENNSYLVANIA AVENUE, NW, SUITE 200, WASHINGTON, DC, 20006, US

(21) Appl. No.: 10/820,876

(22) Filed: Apr. 9, 2004

Related U.S. Application Data
(60) Provisional application No. 60/461,142, filed on Apr. 9, 2003.

(51) Int. Cl. G06Q 40/00

(52) U.S. Cl. 705/37

(57) ABSTRACT

The present invention relates to a method and system for providing a financial instrument by integrating a convertible security with a call spread to form a financial instrument having the benefits of low coupons and tax efficiencies. The call spread includes a first call option that mirrors features of the convertible security and a second call option that has a higher strike price than that of the first call option.

### PRIORITY

This application claims priority to U.S. Provisional Patent Application No. 60/461,142, filed Apr. 9, 2004, entitled, “SYSTEM AND METHOD FOR INTEGRATING A CONVERTIBLE SECURITY WITH A CALL SPREAD,” which is herein incorporated by reference in its entirety.

### BACKGROUND OF THE INVENTION

1. Field of the Invention

The present invention relates to the field of financial instruments. More particularly, the present invention relates to a system and method for integrating a convertible security with a call spread to form a financial instrument having the benefits of low coupons and tax efficiencies.

2. Background

As known in the art, business entities (e.g., companies, corporations) issue and sell financial instruments for capital-raising activities. Among several corporate finance alternatives, business entities that need to raise capital can enter the bond market to issue high-yield bonds or the convertible market to issue convertible securities to attract potential investors. With high-yield bonds, business entities as bond issuers must pay out high-interest coupons on the bonds. With convertible securities, business entities as convertible issuers may have lower-interest coupons to pay out but instead suffer the potential for diluting earnings per share (EPS) and increasing the number of shares outstanding that will occur as a result of the exercise of the conversion rights.

### SUMMARY OF THE INVENTION

Hence, there exists a need for a system and method for a financial instrument that is both tax efficient and accounting efficient to the issuer.

Accordingly, one embodiment of the present invention provides a financial instrument comprising: a convertible security providing a first potential financial benefit; a first call option when exercised provides a second potential financial benefit substantially the same as the first potential financial benefit; and a second call option when exercised provides a third potential financial benefit different from the second potential financial benefit.

Another embodiment of the present invention provides a method for structuring a financial instrument comprising: first providing a convertible security having a first potential financial benefit; second providing a first call option that when exercised provides a second potential financial benefit substantially the same as the first potential financial benefit; and third providing a second call option that when exercised provides a third potential financial benefit different from the second potential financial benefit.

### BRIEF DESCRIPTION OF THE DRAWINGS

The preferred embodiments are illustrated by way of example and not limited in the following figure(s), in which:

FIG. 1 depicts a diagram showing a high-level structure of the integrated convertible option security (ICON) product in accordance with an embodiment of the present invention; and

FIG. 2 depicts a first portion of an example of an ICON structure shown in FIG. 1, in accordance with an embodiment of the present invention; and

FIG. 3 depicts a second portion of an example of an ICON structure shown in FIG. 1, in accordance with an embodiment of the present invention.

### DETAILED DESCRIPTION OF THE INVENTION

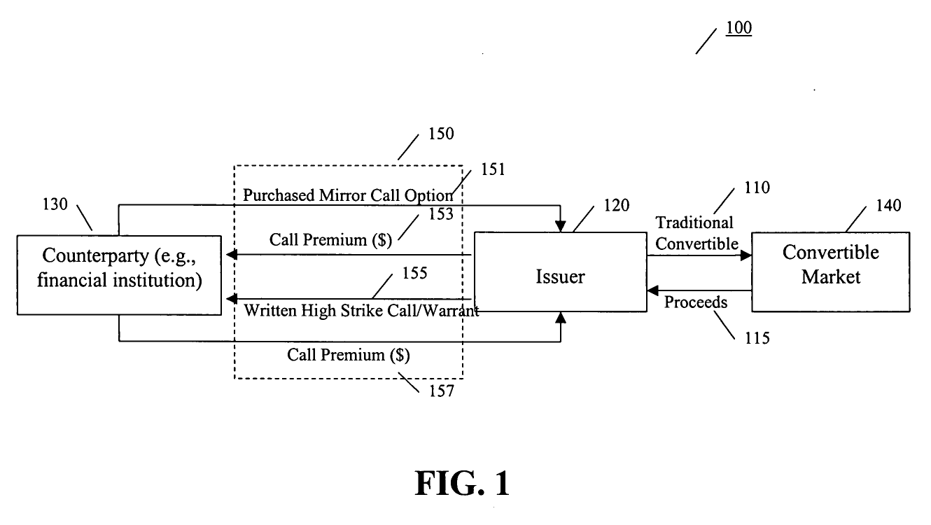

Reference is now made in detail to embodiments of the present invention, some examples of which are illustrated in the accompanying drawings, in which like numerals indicate like elements, showing a method and system for integrating a convertible security with a call spread to form a financial instrument having the benefits of low coupons and tax efficiencies. FIG. 1 depicts a diagram showing a high-level structure 100 of an integrated convertible option security (ICON) product that can be issued and sold by, e.g., a business entity as an issuer to the convertible market, in accordance with an embodiment of the present invention. As shown, the ICON product is structured to include: 1) a traditional cash pay convertible security (note, bond, etc.) 110 that the issuer 120 sells to, e.g., an investor in the convertible market 140; and 2) a call spread 150 that the issuer separately enters into with a counterparty, such as a financial institution 130.

For the call spread 150, the issuer 120 can use a portion of the proceeds 115 from the sales of the traditional convertible security 110, or any desired funds, to: a) repurchase, at a call premium 153, a first call option 151 (having a first strike price) from the counterparty that “mirrors” the conversion features of the convertible security 110; and b) simultaneously sells, for a call premium 157, a separate second call option 155 to the counterparty 130 at a higher strike price with features that do not match those of the first call option 151. Alternatively, the issuer 120 can sell the second call option 155 to a counterparty other than the counterparty 130 from which the issuer 120 has purchased the first call option 151.

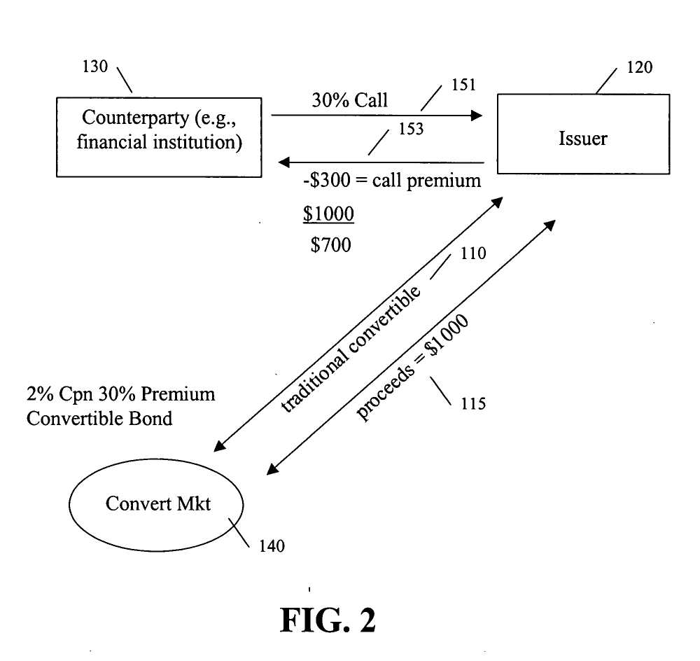

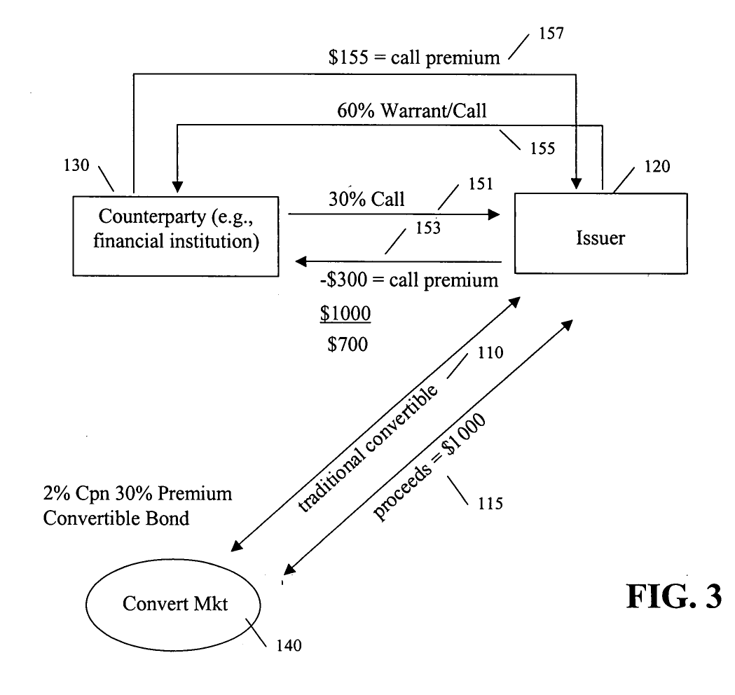

An example of an ICON product in accordance with the ICON structure shown in FIG. 1 is now provided with reference to FIGS. 2-3. In this example, the type of convertible security, sample values for parameters of the convertible security, purchased call option, and written call option, and the resulting benefits based on the chosen sample values are provided. However, it should be understood that the type of convertible security and other ICON parameters can be different from the shown sample so long as they conform to the criteria disclosed herein.

Referring to FIG. 2 for the example, the issuer 120 sells to the convertible market 140 a traditional cash-pay convertible security 110 in the form of a five-year, non-callable convertible bond with 30% premium over bond value and a 2% semi-annual coupon (i.e., interest rate). In this example, the issuer 120 receives $1000 as the proceeds 115 of the sale.

Next, the issuer 120 can use a portion of the $1000 proceeds, or any desired funds, to purchase a first call option 151 from the counterparty 130 for $300. The first call option 151 is a “mirror” call option with respect to the aforementioned convertible bond 110 in that it reflects the same conversion price (e.g., 30% premium price) and other features (e.g., an option to purchase the same number of shares that the convertible bond 110 can be converted into) of the convertible bond 110. The issuer 120 can identify the purchased “mirror” call option 151 and the convertible bond 110 as a single integrated transaction for tax purposes. In other words, because the cash flows on the purchased “mirror” call option match the cash flows on the convertible bond, the issuer 120 is treated as having issued a 2% coupon debt instrument (i.e., the 2% semi-annual coupon) with $300 of original issue discount (OID). The $300 OID may be deductible as additional interest expense amortized on a constant yield to maturity basis over the life of the convertible bond 110.

As mentioned earlier, the ICON structure 100 also includes the issuer 120 simultaneously selling a separate second call option 155 to the counterparty 130 at a higher strike price with features that do not match those of the first call option 151. FIG. 3 depicts this particular transaction for the running example. Because the second call option 155 is to be issued by the issuer 120, such option is in the form of a written warrant 155. As understood in the art, a warrant is issued and guaranteed by an issuer of the underlying security; whereas, a call option is an exchange instrument and not issued by the issuer of the underlying security. In the running example, if the issuer 120 believes that market prices make it attractive to issue warrants at a higher strike price than the convertible market typically accepts on the convertible bond 110, the issuer 120 may sell, e.g., a 60%-premium warrant 155 to the counterparty 130 for $155. Thus, such warrant has a higher strike price than the 30%-premium convertible bond 110. The warrant 155 can have at least one or more of the following features:
the warrant 155 can be exercised by the counterparty 130 at any time;
the maturity of the warrant 155 will be at least a period of time, e.g., 30-90 days, after the maturity of the convertible bond 110 and call option 151, wherein such time period can be set by the issuer 120 as desired or needed.
the warrant will specifically provide that any International Swaps and Derivatives Association (ISDA) provisions relating to netting of obligations and offsets in bankruptcy will not apply; e.g., the purchased call option 151 and written warrant 155 cannot be netted as a credit matter or in the event of a bankruptcy of the issuer 120;
for accounting purposes, the call option 151 and the warrant 155 can be netted and accounted as a purchased call spread, wherein the net premium amount can be account for as additional paid in capital (APIC); and
the warrant 155 will relate to more or less than 100% of the number of shares covered by the convertible bond 110 and call option 151.
   The aforementioned features, or any other desirable separation features, are used separate the warrant 155 from the aforementioned integrated transaction involving the convertible bond 110 and call option 151, thereby preserving full deductibility of the $300 OID on the integrated transaction.

Hence, the ICON product according to embodiments of the present invention can be structured to achieve favorable tax treatment under the current U.S. tax codes for the issuer while preserving separate accounting for the convertible security and the call spread. Particularly, the issuer can identify the “mirror” lower-strike call option and the convertible security as a single integrated transaction for tax purposes. For instance, the cash flows on the purchased lower-strike call option can be designed to match the cash flows on the convertible so that the issuer can be treated as having issued a fixed rate debt instrument security with an original issue discount (OID) equal to the amount of the premium for the lower-strike call option. As a result, the OID is deductible as an additional interest expense amortized on a constant yield to maturity basis over the life of the convertible security. Yet, for accounting purposes, the book-interest expense can be limited to the coupon on the convertible security. Furthermore, as mentioned earlier, the features of the written (higher-strike) call option can be designed to be non-matching with those of the purchased (lower-strike) call option. This allows for separate, non-integrated tax treatment from the integrated transaction to thereby preserve the full deductibility of the OID on the integrated transaction.

The preferred embodiments of the present invention also provide an ICON product that allows the issuer to increase the effective conversion premium, while reflecting a low interest expense for EPS purposes. The pairing of a call spread with a convertible security in the ICON product allows the issuer to efficiently repurchase the shares underlying the security and thus minimize dilution.

Although the invention has been described with reference to these preferred embodiments, other embodiments could be made by those in the art to achieve the same or similar results. Variations and modifications of the present invention will be apparent to one skilled in the art based on this disclosure, and the present invention encompasses all such modifications and equivalents.

1. A method for performing a financial transaction with a counterparty and an investor, the method comprising the steps of:
issuing to the investor a convertible security providing a first potential financial benefit; and
establishing a call spread with the counterparty, comprising the steps of:
buying from the counterparty a first call option having a second potential financial benefit that is based upon and is the same as the first potential financial benefit; and
selling to the counterparty a second call option with a higher strike price than the first call option that when exercised provides a third potential financial benefit different from the second potential financial benefit.

2. The method of claim 1, wherein the convertible security is issued by an issuer, the first call option is purchased by the issuer, and the second call option comprises a warrant issued by the issuer.

3. The method of claim 1, wherein the first potential financial benefit comprises a first predetermined number of units of an underlying security into which the convertible security can be converted.

4. The method of claim 3, wherein the first call option comprises an option to purchase the first predetermined number of units of the underlying security.

5. The method of claim 3, wherein the second call option comprises an option to purchase a second predetermined number of units of the underlying security that is different from the first predetermined number.

6. The method of claim 1, wherein the convertible security is issued at a first price.

7. The method of claim 6, wherein the first call option when exercised requires a payment of the first price.

8. The method of claim 7, wherein the second call option when exercised requires a payment of a second price higher than the first price.

9. The method of claim 1, wherein the convertible security comprises a convertible note or a convertible bond.

10. The method of claim 1, wherein the first call option is purchased by an issuer of the convertible security from a counterparty, and the second call option is a warrant sold by the issuer to the counterparty.

11. The method of claim 1, wherein the difference between the first call option and the second call option constitutes a call spread.

12. A method for issuing a financial instrument comprising a convertible security, a first call option, and a second call option, the method comprising the steps of:
issuing a convertible security from an issuer to an investor having a first potential financial benefit;
issuing a first call option from a first counterparty to the issuer having a second potential financial benefit that is based upon and is the same as the first potential financial benefit; and
issuing a second call option from the issuer to either the first counterparty or a second counterparty that when exercised provides a third potential financial benefit different from the second potential financial benefit.

13. The method of claim 12, wherein:
the first call option is purchased by the issuer; and
the second call option is issued as a warrant by the issuer.

14. The method of claim 12, wherein the first potential financial benefit comprises a first predetermined number of units of an underlying security into which the convertible security can be converted.

15. The method of claim 14, wherein issuing a first call option comprises:
providing an option to purchase the first predetermined number of units of the underlying security.

16. The method of claim 14, wherein issuing a second call option comprises:
providing an option to purchase a second predetermined number of units of the underlying security that is different from the first predetermined number.

17. The method of claim 12, wherein the convertible security is issued at a first price.

18. The method of claim 17, wherein first call option when exercised requires a payment of the first price.

19. The method of claim 18, wherein the second call option when exercised requires a payment of a second price higher than the first price.

20. The method of claim 12, wherein the convertible security comprises a convertible note or a convertible bond.

21. The method of claim 12, wherein the second call option is issued as a warrant to the counterparty.

22. The method of claim 12, wherein the difference between the first call option and the second call option constitutes a call spread.

23. The method of claim 1, wherein the first call option is purchased by an issuer of the convertible security from a first counterparty, and the second call option is a warrant sold by the issuer to second counterparty different than the first counterparty.

24. The method of claim 12, wherein the first call option is issued by the first counterparty; and the second call option is sold as a warrant to the second counterparty.

25. The method of claim 1, wherein:
the convertible security is-convertible into a first predetermined number of units of an underlying security;
the first call option is exercisable to purchase a second predetermined number of units of the underlying security upon the occurrence of a first predetermined event, wherein the first predetermined number of units of an underlying security is equal to the second predetermined number of units of an underlying security; and
the second call option exercisable to purchase a third predetermined number of units of the underlying security upon the occurrence of a second predetermined event, wherein the first predetermined number of units of an underlying security is different from the third predetermined number of units of an underlying security.

26. The method of claim 1, wherein the first potential financial benefit, second potential financial benefit, or third potential financial benefit is a predetermined number of units of an underlying security.

27. The method of claim 1, wherein:
a conversion price of the first call option is the same as a conversion price of the convertible security;
an original issue discount of the convertible security equals the amount of a premium for the lower-strike call option; and
the original issue discount is deductible as an interest expense amortized on a constant yield to maturity basis over the life of the convertible security.

28. A method for performing a financial transaction with a convertible security, a first call option, and a second call option, the financial transaction being between an issuer, a first counterparty, a second counterparty, and an investor, the method comprising the steps of:
issuing from the issuer to the investor the convertible security providing a first potential financial benefit, wherein the convertible security is convertible into a first predetermined number of units of an underlying security; and
buying by an issuer from the first counterparty, with at least a portion of the proceeds from the issuance of the convertible security, the first call option having a second potential financial benefit that is based upon and is the same as the first potential financial benefit, wherein the first call option is exercisable to purchase a second predetermined number of units of the underlying security upon the occurrence of a first predetermined event; and
selling by an issuer, simultaneous to the buying of the first call option, to the second counterparty the second call option with a higher strike price than the first call option that when exercised provides a third potential financial benefit different from the second potential financial benefit, wherein the second call option exercisable to purchase a third predetermined number of units of the underlying security upon the occurrence of a second predetermined event.

29. The method of claim 28, wherein the second call option is a warrant.

30. The method of claim 28, wherein the first counterparty is the second counterparty.
